(19) United States
(12) Patent Application Publication
(10) Pub. No.: US 2016/0341290 A1
(43) Pub. Date: Nov. 24, 2016

(54) BELT TRANSMISSION MECHANISM

(71) Applicant: Foxlink Image Technology Co., Ltd., New Taipei City (TW)

(72) Inventors: Ming Wei Lin, New Taipei City (TW); Wen Ching Liao, New Taipei City (TW)

(21) Appl. No.: 14/717,268

(22) Filed: May 20, 2015

(51) Int. Cl. F16H 7/08; F16H 7/02

(52) U.S. Cl. CPC F16H 7/08; F16H 7/02; F16H 2007/0872; F16H 2007/0842

(57) ABSTRACT

A belt transmission mechanism includes a driving pulley, a following pulley mounted on a shaft, a timing belt looping around the driving pulley and the corresponding following pulley, and a belt limiter. When the driving pulley rotates, the timing belt has a tight side and a slack side. The belt limiter has a mounting portion rotatably mounted on the shaft and located behind the following pulley. A portion of an outer periphery of the mounting portion adjacent to the slack side extends outward to form a connecting portion. One end of the connecting portion adjacent to the slack side extends forward to form a limiting board which is attached to an outer surface of the slack side. The limiting board is tangent to and spaced from an outer periphery of the following pulley to make the slack side continuously engaged with the following pulley in a tangential direction.

### BACKGROUND OF THE INVENTION

1. Field of the Invention

The present invention generally relates to a belt transmission mechanism, and more particularly to a belt transmission mechanism capable of effectively eliminating a slippage phenomenon.

2. The Related Art

Usually, a belt transmission mechanism transmits driving forces by virtue of a timing belt and at least two pulleys. In the process of the belt transmission mechanism transmitting the driving forces by virtue of the timing belt and the pulleys, a slippage phenomenon is probable to be generated on account of the timing belt being overly loose.

Referring to FIG. 1, in a prior art, a first belt transmission mechanism 100′ includes a first driving pulley 10′, a first following pulley 20′ and a first timing belt 30′. The first timing belt 30′ loops around the first driving pulley 10′ and the first following pulley 20′. When the first driving pulley 10′ rotates clockwise to drive the first following pulley 20′ to rotate clockwise, an upper belt portion of the first timing belt 30′ is defined as a first tight side 31′, and a lower belt portion of the first timing belt 30′ is defined as a first slack side 32′. When the first slack side 32′ is overly loose, the slippage phenomenon is probable to be generated at a place of the first slack side 32′ being engaged with the first following pulley 20′.

Referring to FIG. 2, in another prior art, in order to effectively eliminate the slippage phenomenon, a second belt transmission mechanism 200′ is provided. The second belt transmission mechanism 200′ includes a second driving pulley 40′, a second following pulley 50′, a second timing belt 60′, a pressure roller 70′ and a torsion spring 80′. The pressure roller 70′ is pressed against the second timing belt 60′ tightly to effectively eliminate the slippage phenomenon. So a stability of the second timing belt 60′ transmitting the driving force is enforced by virtue of increasing the pressure roller 70′. When the second driving pulley 40′ rotates clockwise to drive the second following pulley 50′ to rotate clockwise, an upper belt portion of the second timing belt 60′ is defined as a second tight side 61′, and a lower belt portion of the second timing belt 60′ is defined as a second slack side 62′.

However, the pressure roller 70′ is pressed against the second slack side 62′ by virtue of the torsion spring 80′ supporting the pressure roller 70′. Moreover, if positions or angles of the second driving pulley 40′, the second following pulley 50′ and the second timing belt 60′ are different, a position relationship between the pressure roller 70′ and the torsion spring 80′ must be redesigned. As a result, a cost of the second belt transmission mechanism 200′ and working hours of assembling the second belt transmission mechanism 200′ are sharply increased.

### SUMMARY OF THE INVENTION

An object of the present invention is to provide a belt transmission mechanism. The belt transmission mechanism includes a driving pulley, a following pulley, a timing belt and a belt limiter. The following pulley is mounted on a shaft. The timing belt loops around the driving pulley and the corresponding following pulley. When the driving pulley rotates, the timing belt has a tight side and a slack side facing each other. The belt limiter has a mounting portion rotatably mounted on the shaft and located behind the following pulley. A portion of an outer periphery of the mounting portion adjacent to the slack side of the timing belt extends outward to form a connecting portion beyond the slack side. One end of the connecting portion adjacent to the slack side extends forward to form a limiting board which is attached to an outer surface of the slack side. The limiting board is tangent to and spaced from an outer periphery of the following pulley to make the slack side continuously engaged with the following pulley in a tangential direction.

As described above, the limiting board is tangent to the outer periphery of the following pulley to make the slack side continuously engaged with the following pulley in the tangential direction, and simultaneously, the locating board cooperates with the limiting board to position the slack side of the timing belt so as to ensure the timing belt and the following pulley to rotate synchronously for effectively eliminating a slippage phenomenon. As a result, a cost of the belt transmission mechanism and working hours of assembling the belt transmission mechanism are dramatically decreased.

### BRIEF DESCRIPTION OF THE DRAWINGS

The present invention will be apparent to those skilled in the art by reading the following description, with reference to the attached drawings, in which:

FIG. 1 is a perspective view of a first belt transmission mechanism in a prior art;

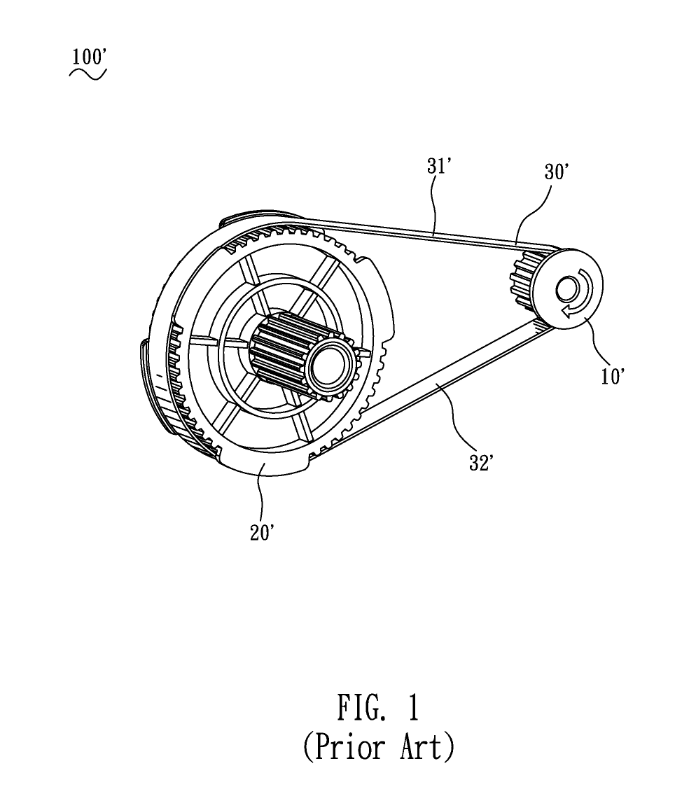

FIG. 2 is a perspective view of a second belt transmission mechanism in another prior art;

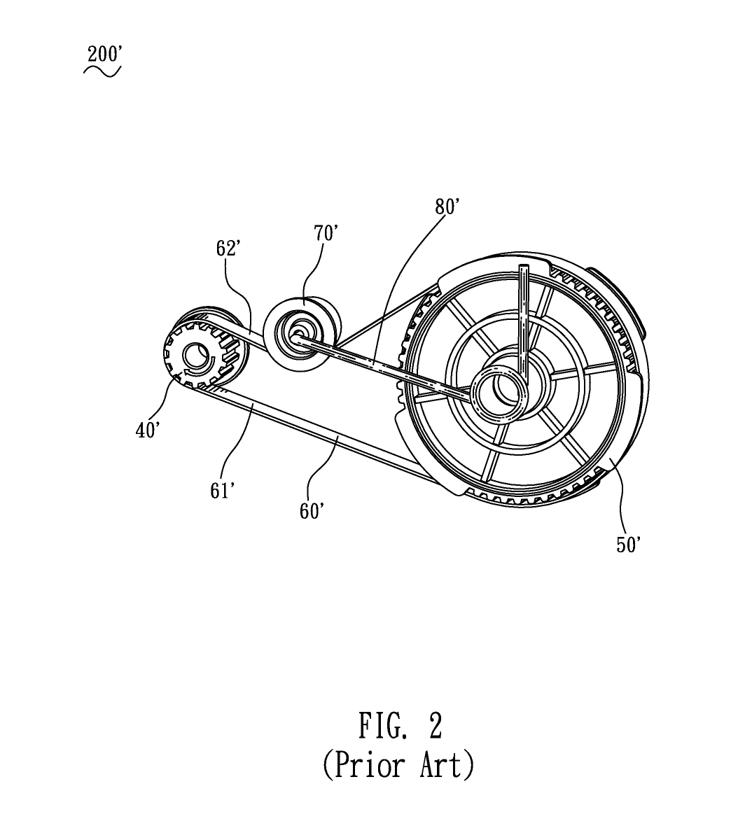

FIG. 3 is a perspective view of a belt transmission mechanism in accordance with a first embodiment of the present invention;

FIG. 4 is a perspective view of a belt limiter of the belt transmission mechanism of FIG. 3; and

FIG. 5 is a perspective view of the belt transmission mechanism in accordance with a second embodiment of the present invention.

### DETAILED DESCRIPTION OF THE PREFERRED EMBODIMENT

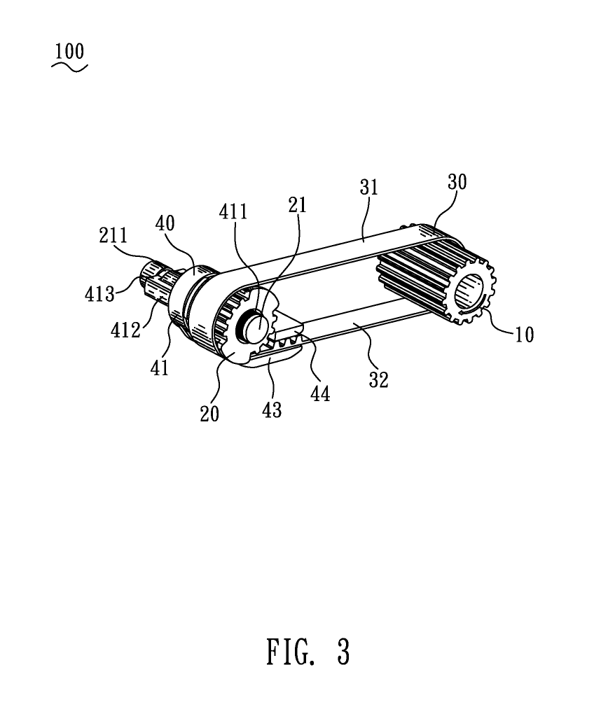

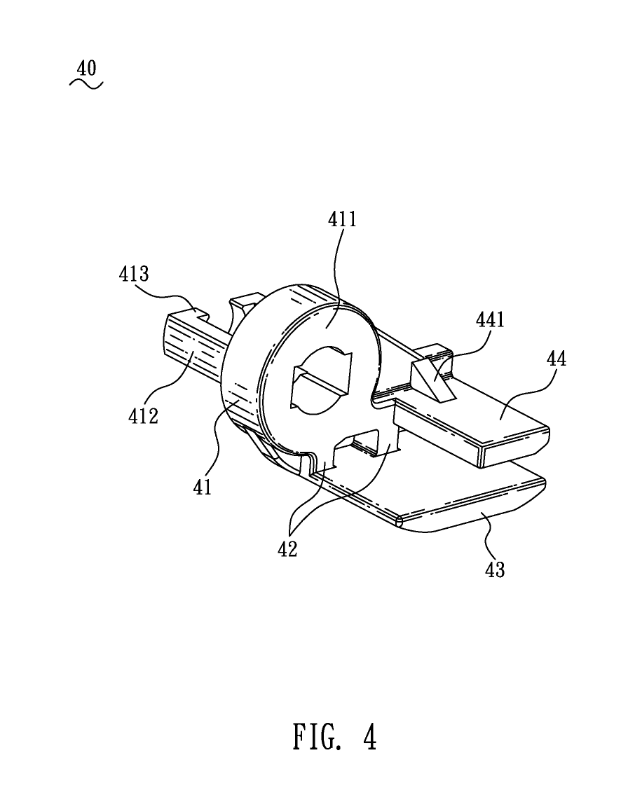

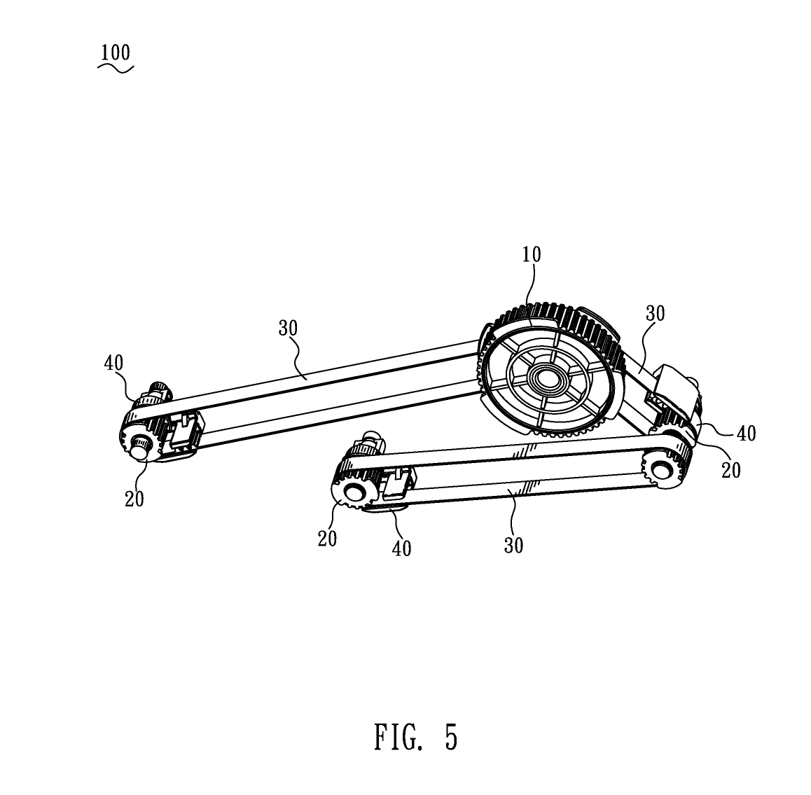

With reference to FIG. 3, FIG. 4 and FIG. 5, a belt transmission mechanism 100 in accordance with the present invention is shown. The belt transmission mechanism 100 in accordance with a first embodiment of the present invention includes a driving pulley 10, a following pulley 20, a timing belt 30 and a belt limiter 40. The timing belt 30 loops around the driving pulley 10 and the corresponding following pulley 20 for transmitting driving forces between the driving pulley 10 and the corresponding following pulley 20.

With reference to FIG. 3 and FIG. 4, when the driving pulley 10 rotates, the timing belt 30 has a tight side 31 and a slack side 32 facing each other. The tight side 31 and the slack side 32 are driven by the driving pulley 10 to move oppositely. When the driving pulley 10 rotates clockwise to drive the following pulley 20 to rotate clockwise by virtue of the timing belt 30, an upper belt portion of the timing belt 30 is defined as the tight side 31, and a lower belt portion of the timing belt 30 is defined as the slack side 32.

With reference to FIG. 3 and FIG. 4, the belt limiter 40 has a mounting portion 41. The following pulley 20 is mounted on a shaft 21. A rear end of the shaft 21 is recessed inward to form a ring-shaped restricting groove 211. The mounting portion 41 is rotatably mounted on the shaft 21 and located behind the following pulley 20. The mounting portion 41 is adjacent to and spaced from the following pulley 20. The mounting portion 41 defines a mounting hole 411 longitudinally penetrating through a middle of the mounting portion 41. The shaft 21 rotatably passes through the mounting hole 411 of the mounting portion 41.

With reference to FIG. 3 and FIG. 4, a portion of an outer periphery of the mounting portion 41 adjacent to the slack side 32 of the timing belt 30 extends outward to form a connecting portion 42 beyond the slack side 32. The connecting portion 42 is located behind the slack side 32. One end of the connecting portion 42 adjacent to the slack side 32 extends forward to form a limiting board 43. The limiting board 43 is attached to an outer surface of the slack side 32. The limiting board 43 is tangent to and is spaced from an outer periphery of the following pulley 20 to make the slack side 32 continuously engaged with the following pulley 20 in a tangential direction.

With reference to FIG. 3 and FIG. 4, the connecting portion 42 further extends forward to form a locating board 44 facing to the limiting board 43 and located between the following pulley 20 and the driving pulley 10. The locating board 44 is spaced from and parallel to the limiting board 43. The locating board 44 is disposed to an inside of the slack side 32 to cooperate with the limiting board 43 to position the slack side 32 of the timing belt 30. The limiting board 43 is located adjacent to the outer periphery of the following pulley 20. The locating board 44 is located adjacent to and spaced from the outer periphery of the following pulley 20. A surface of the locating board 44 away from the limiting board 43 protrudes upward to form a reinforcing portion 441 connected with the connecting portion 42. The reinforcing portion 441 provides a reinforcing force for the locating board 44. The reinforcing portion 441 is shown a triangle shape from a lateral view.

With reference to FIG. 3 and FIG. 4, two opposite sides of the mounting portion 41 extend rearward to form two clamping arms 412 located at two opposite sides of the mounting hole 411. The two clamping arms 412 clamp two opposite sides of the shaft 21. Two free ends of the two clamping arms 412 protrude face to face to form two restricting portions 413. The restricting portions 413 are restricted in the restricting groove 211 of the shaft 21.

With reference to FIG. 3 and FIG. 4, the driving pulley 10 rotates clockwise to drive the following pulley 20 to rotate clockwise by virtue of the tight side 31 being pulled tightly. The slack side 32 of the timing belt 30 shows a loose status in the rotation process of the driving pulley 10 and the following pulley 20. The following pulley 20 rotates clockwise to drive the shaft 21 to rotate clockwise. At the moment, the limiting board 43 is tangent to the outer periphery of the following pulley 20 to make the slack side 32 continuously engaged with the following pulley 20 in the tangential direction. Simultaneously, the locating board 44 cooperates with the limiting board 43 to position the slack side 32 of the timing belt 30 so as to ensure the timing belt 30 and the following pulley 20 to rotate synchronously for effectively eliminating the slippage phenomenon. The slack side 32 is guided between the locating board 44 and the limiting board 43. The outer surface and the inside of the slack side 32 of the timing belt 30 are capable of rubbing against the limiting board 43 and the locating board 44, respectively.

With reference to FIG. 3, FIG. 4 and FIG. 5, the belt transmission mechanism 100 in accordance with a second embodiment of the present invention is shown. A difference between the belt transmission mechanism 100 in accordance with the first embodiment and the belt transmission mechanism 100 in accordance with the second embodiment is described as follows. The belt transmission mechanism 100 in accordance with the first embodiment includes a group of the driving pulley 10, the following pulley 20, the timing belt 30 and the belt limiter 40. The belt transmission mechanism 100 in accordance with the second embodiment includes multiple groups of the driving pulley 10, the following pulley 20, the timing belt 30 and the belt limiter 40.

With reference to FIG. 3, FIG. 4 and FIG. 5, the belt transmission mechanism 100 is not limited to include one group of the driving pulley 10, the following pulley 20, the timing belt 30 and the belt limiter 40, and is not limited to apply one belt limiter 40. Multiple belt limiters 40 are capable of being applied to the belt transmission mechanism 100 in different angles, positions and directions. In use, the limiting board 43 is attached to the outer surface of the slack side 32. The limiting board 43 is tangent to and is spaced from the outer periphery of the following pulley 20 to make the slack side 32 continuously engaged with the following pulley 20 in the tangential direction.

As described above, the limiting board 43 is tangent to the outer periphery of the following pulley 20 to make the slack side 32 continuously engaged with the following pulley 20 in the tangential direction, and simultaneously, the locating board 44 cooperates with the limiting board 43 to position the slack side 32 of the timing belt 30 so as to ensure the timing belt 30 and the following pulley 20 to rotate synchronously for effectively eliminating the slippage phenomenon. As a result, a cost of the belt transmission mechanism 100 and working hours of assembling the belt transmission mechanism 100 are dramatically decreased.

What is claimed is:

1. A belt transmission mechanism, comprising:
a driving pulley;
a following pulley mounted on a shaft;
a timing belt looping around the driving pulley and the corresponding following pulley, when the driving pulley rotates, the timing belt having a tight side and a slack side facing each other; and
a belt limiter having a mounting portion rotatably mounted on the shaft and located behind the following pulley, a portion of an outer periphery of the mounting portion adjacent to the slack side of the timing belt extending outward to form a connecting portion beyond the slack side, one end of the connecting portion adjacent to the slack side extending forward to form a limiting board which is attached to an outer surface of the slack side, the limiting board being tangent to and spaced from an outer periphery of the following pulley to make the slack side continuously engaged with the following pulley in a tangential direction.

2. The belt transmission mechanism as claimed in claim 1, wherein the connecting portion further extends forward to form a locating board facing to the limiting board and located between the following pulley and the driving pulley, the locating board is spaced from and parallel to the limiting board, the locating board is disposed to an inside of the slack side to cooperate with the limiting board to position the slack side of the timing belt.

3. The belt transmission mechanism as claimed in claim 2, wherein the locating board is located adjacent to and spaced from the outer periphery of the following pulley.

4. The belt transmission mechanism as claimed in claim 2, wherein a surface of the locating board away from the limiting board protrudes outward to form a reinforcing portion connected with the connecting portion, the reinforcing portion provides a reinforcing force for the locating board.

5. The belt transmission mechanism as claimed in claim 4, wherein the reinforcing portion is shown a triangle shape.

6. The belt transmission mechanism as claimed in claim 1, wherein a rear end of the shaft is recessed inward to form a ring-shaped restricting groove, two opposite sides of the mounting portion extend rearward to form two clamping arms, the two clamping arms clamp two opposite sides of the shaft, two free ends of the two clamping arms protrude face to face to form two restricting portions, the restricting portions are restricted in the restricting groove.

7. The belt transmission mechanism as claimed in claim 1, wherein the mounting portion is adjacent to and spaced from the following pulley.

8. The belt transmission mechanism as claimed in claim 1, wherein the mounting portion defines a mounting hole longitudinally penetrating through a middle of the mounting portion, the shaft rotatably passes through the mounting hole of the mounting portion.
